(19) United States
(12) Patent Application Publication
(10) Pub. No.: US 2009/0219432 A1
(43) Pub. Date: Sep. 3, 2009

(54) SENSOR WITH MULTI-PERSPECTIVE IMAGE CAPTURE

(76) Inventors: Russell J. Palum, Rochester, NY (US); John N. Border, Walworth, NY (US); James E. Adams, JR., Rochester, NY (US); Joseph R. Bietry, Rochester, NY (US)

Correspondence Address: David A. Novais;Patent Legal Staff, Eastman Kodak Company, 343 State Street, Rochester, NY, 14650-2201, US

(21) Appl. No.: 12/040,274

(22) Filed: Feb. 29, 2008

(51) Int. Cl. H04N 5/225

(52) U.S. Cl. 348/340; 348/E05.024

(57) ABSTRACT

The invention discloses an image acquisition system with a modified image sensor that enables simultaneous capture of at least two images with different perspectives The pixels are split into two or more subsets of pixels under a series of cylindrical microlenses or linear light guides. The cylindrical microlenses or linear light guides limit the radiation to impinge upon first and second subsets of pixels under each microlens or light guide to come from only one half or the other half of the imaging lens so that stereo image sets are produced.

### FIELD OF THE INVENTION

The invention pertains to an image sensor that captures radiation from a scene. The invention further pertains to an image sensor with cylindrical microlenses that enable simultaneous capture of multiple images with different perspectives.

### BACKGROUND OF THE INVENTION

Stereo image capture composed of two or more images captured from two or more cameras that are separated by a distance to provide different perspectives is well known in the art. However, these multiple camera systems are bulky and difficult to align or calibrate due to the large size of such systems.

Stereo cameras with two or more lenses are also known in the art. U.S. patent application Ser. No. 11/684,036, filed Mar. 9, 2007, by John N. Border et al., in the name of Eastman Kodak Company, discloses the use of a camera with two or more lenses that capture images simultaneously to produce a rangemap based on the differences from the different perspectives in the two more images.

In U.S. Pat. No. 6,545,741 by Meltzer, a stereo camera with two lens systems that direct light to a single image sensor is described. Images are produced in pairs by sequentially capturing images through each lens system. Sequential switching back and forth between the lens systems is accomplished by shutters.

In U.S. Pat. No. 6,072,627 by Nomura et al., a stereo image capture device is described which uses an afocal lens assembly to present an image to an array of lenses or slits that focus the light beams onto a series of pixels on an image sensor in such a way that the intensity and angle of the light beams can be recorded.

However, the methods presented in the prior art require special lens assemblies that increase the complexity and size of the stereo camera. Therefore the need persists for a simple sensor system that can be used with any imaging lens to enable a camera to capture stereo images without increasing complexity.

### SUMMARY OF THE INVENTION

The invention discloses an image acquisition system with a modified image sensor that enables simultaneous capture of at least two images with different perspectives. The pixels are split into two or more subsets of pixels under a series of cylindrical microlenses or linear light guides. The cylindrical microlenses or linear light guides limit the radiation to impinge upon first and second subsets of pixels under each microlens or light guide to come from only one portion or another portion of the imaging lens so that multi-perspective image sets are produced. The pixel arrangement on the modified image sensor is correspondingly modified to enable uniform image quality to be produced in the stereo images as captured. One of the advantages of the modified image sensor is that it can be used with a wide range of imaging lenses.

### BRIEF DESCRIPTION OF THE DRAWINGS

FIG. 1 is a schematic cross-sectional depiction of a series of light rays traveling through an imaging lens and entering one cylindrical microlens which is positioned over two pixels on an image sensor;

FIG. 2 is a schematic cross-sectional depiction of a series of light rays traveling through an imaging lens and entering a plurality of cylindrical microlenses positioned over a plurality of pixels on an image sensor;

FIG. 3 is a schematic depiction of the imaging lens aperture showing the effective separation of the split aperture produced by the invention;

FIG. 4 is a schematic depiction of a color filter array on an image sensor under the cylindrical microlens array;

FIG. 5 is a schematic depiction of a red/green/blue color filter array pattern as described by the invention wherein the solid lines show the edges of the cylindrical microlens and the dashed lines show the edges of the pixels;

FIG. 6 is a schematic depiction of another red/green/blue color filter array pattern as described by the invention wherein the solid lines show the edges of the cylindrical microlens and the dashed lines show the edges of the pixels;

FIG. 7 is a schematic depiction of a red/green/blue/panchromatic color filter array pattern as described by the invention wherein the solid lines show the edges of the cylindrical microlens and the dashed lines show the edges of the pixels;

FIG. 8 is a schematic depiction of another red/green/blue/panchromatic color filter array pattern as described by the invention wherein the solid lines show the edges of the cylindrical microlens and the dashed lines show the edges of the pixels;

FIG. 9 is a schematic depiction of the cylindrical microlenses with underlying microlenses to help focus the light onto the active area of the pixels;

FIG. 10 is a schematic depiction of a cylindrical microlens with individual microlenses on either side wherein the cylindrical microlens is positioned over panchromatic pixels and the individual microlenses are positioned over red/green/blue pixels;

FIG. 11 is a schematic depiction of an aspheric microlens with a center ridge to better separate the light gathered from the two halves of the imaging lens onto the subsets of pixels on the image sensor; and

FIG. 12 is a schematic cross-sectional depiction of a series of light rays traveling through an imaging lens and entering a plurality of light guides positioned over a plurality of pixels on an image sensor.

### DETAILED DESCRIPTION OF THE INVENTION

The invention includes an image acquisition system including a modified image sensor with a plurality of pixels and a plurality of cylindrical microlenses that cause the light focused onto the pixels underneath to be preferentially gathered from for example, one side or the other of the imaging lens aperture so that stereo images can be produced from the captured pixel data using techniques known in the art. One advantage of the invention is that the modified image sensor can be used with a wide variety of imaging lenses to enable stereo or other multi-perspective images to be captured.

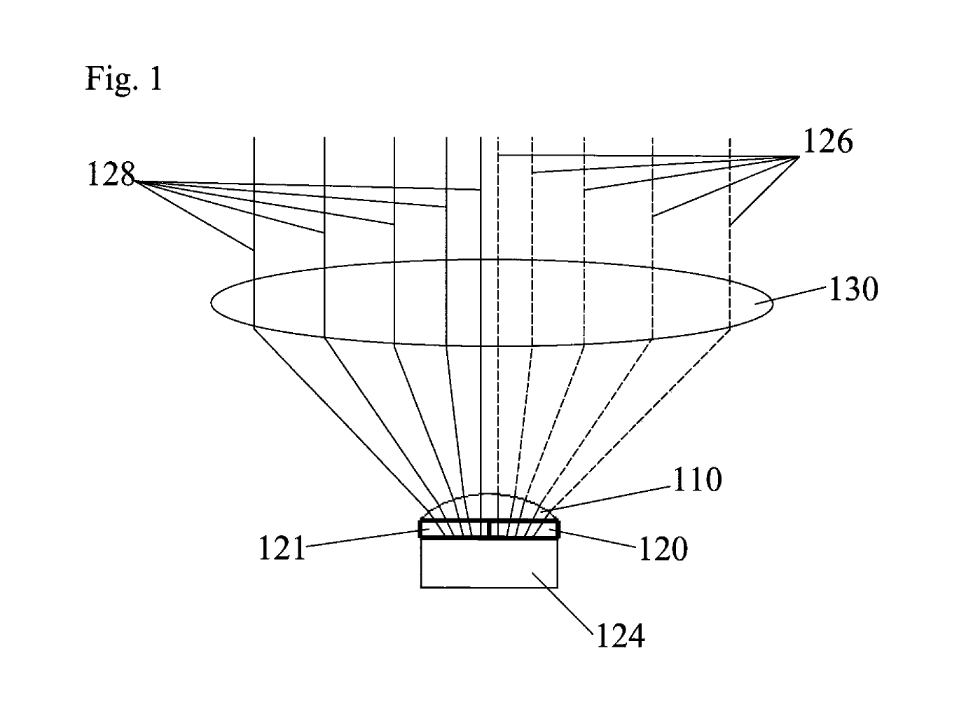

FIG. 1 shows a schematic cross-sectional depiction of a single cylindrical microlens 110 positioned over a subset 120, 121 of a plurality of pixels in the image sensor 124. The cylindrical microlens includes a first portion on the left side of the cylindrical microlens and a second portion on the right side of the cylindrical microlens. The imaging lens 130 focuses incoming radiation (shown as light rays 126 and 128) onto the microlens 110. The microlens 110 causes the radiation that passes through the left side of the imaging lens 130 (light rays 128) to fall onto the pixel 121 on the left side of the image sensor 124. In a complimentary manner, the microlens 110 causes the radiation that passes through the right side of the imaging lens 110 (light rays 126) to fall onto the pixel 120 on the right side of the image sensor 124. Without the microlens 110, the light falling onto the pixels 120 and 121 would be a mixture of radiation that passed through both the left side and the right side of the imaging lens 110 (light rays 126 and 128 combined).

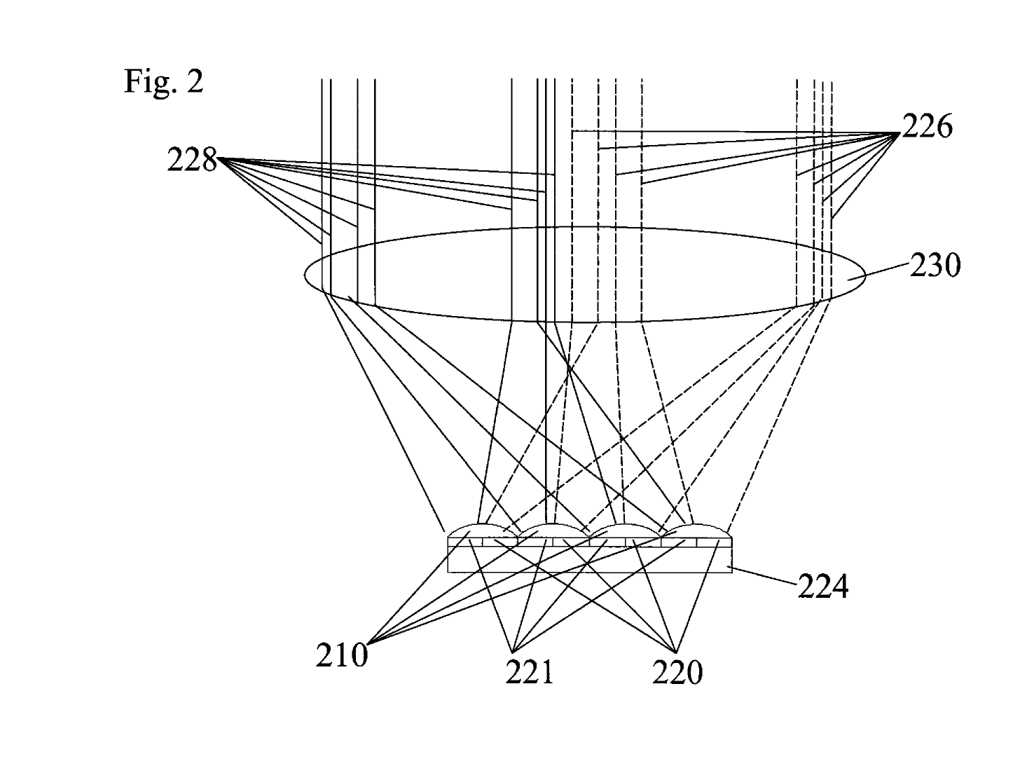

FIG. 2 shows a plurality of cylindrical microlenses 210 positioned over a plurality of respective pixel subsets 120, 121 includes first portions 220 of the pixel subsets and second portions 221 of the pixels subsets on an image sensor 224. It should be noted that while the FIGs. in this disclosure show only a few pixels to illustrate the concepts of the invention, typically image sensors include millions of pixels so that the structures shown in the FIGs would be repeated many times over in an actual image sensor. The imaging lens 230 focuses the incoming radiation (light rays 226 and 228) onto the image sensor 224 including the cylindrical microlenses 210. The cylindrical microlenses 210 preferentially direct the incoming radiation onto the subsets of the plurality of pixels (221 and 220) under the cylindrical microlenses 210 such that, the light that passes through the left side of the imaging lens 228 impinges onto the first portions 221 of the subsets of pixels under the left side of the cylindrical microlenses 210 and the light that passes through the right side of the imaging lens 226 impinges onto the second portions 220 of the second subsets of pixels under the right side of the cylindrical microlenses 210. The pixel data from the first portions 221 of the pixel subset under the left side of the cylindrical microlenses 210 can then be assembled into a first image of the scene being imaged. Likewise, the pixel data from the second portions 220 of the subsets of pixels under the right side of the cylindrical microlenses 210 can be assembled into a second image of the scene being imaged. The aforementioned first image and second image together form a stereo image pair. There will be small differences between the first image of the scene and the second image of the scene due to the difference in perspective caused from the radiation being gathered from the left side or the right side of the imaging lens respectively. Consequently, the first and second images, each having different perspectives, are a stereo-pair, known in the art. The stereo pair can be used to generate a 3 dimensional image for display or use.

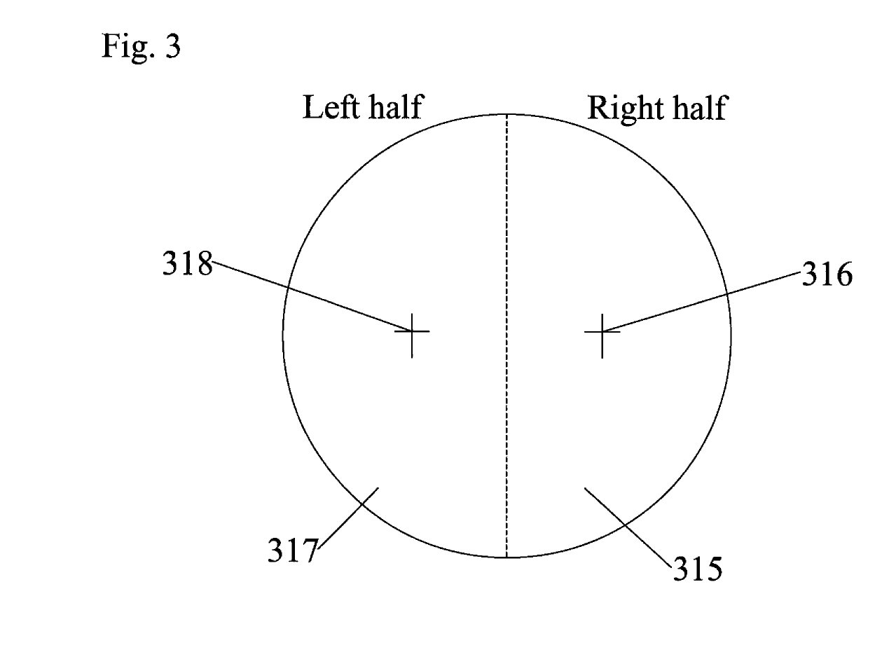

FIG. 3 shows a schematic depiction of the imaging lens aperture with the left and right halves shown as 317 and 315 respectively that may be used to gather the radiation that impinges on the first and second portions of the subsets of pixels 221 and 220 under the cylindrical microlenses 210 located on the left and right sides on the image sensor 224 as shown in FIG. 2. By using pixel data gathered from radiation from only the left half of the imaging lens aperture 317, the perspective provided in the first image is as if the imaging lens is centered at the centroid of the left half of the imaging lens aperture 318. Likewise, by using pixel data gathered from radiation from only the right half of the imaging lens aperture 315 the perspective provided in the second image is as if the imaging lens is centered at the centroid of the right half of the imaging lens aperture 316. Consequently, the perspective difference between the first and second images provided by the invention is the distance between the centroid of the left half of the imaging lens aperture 318 and the centroid of the right half of the imaging lens aperture 316. For a circular imaging lens aperture, the distance D between the centroid of the left half of the imaging lens aperture 318 and the centroid of the right half of the imaging lens aperture 316 is given by Eqn. 1 and can be approximated as D=0.42d where d is the diameter of the imaging lens aperture.

D=4d/3π Eqn. 1

In cases that the diameter d is small, the stereo-pair may have to be enhanced based on a range-map generated from the first and second images, as is known in the art.

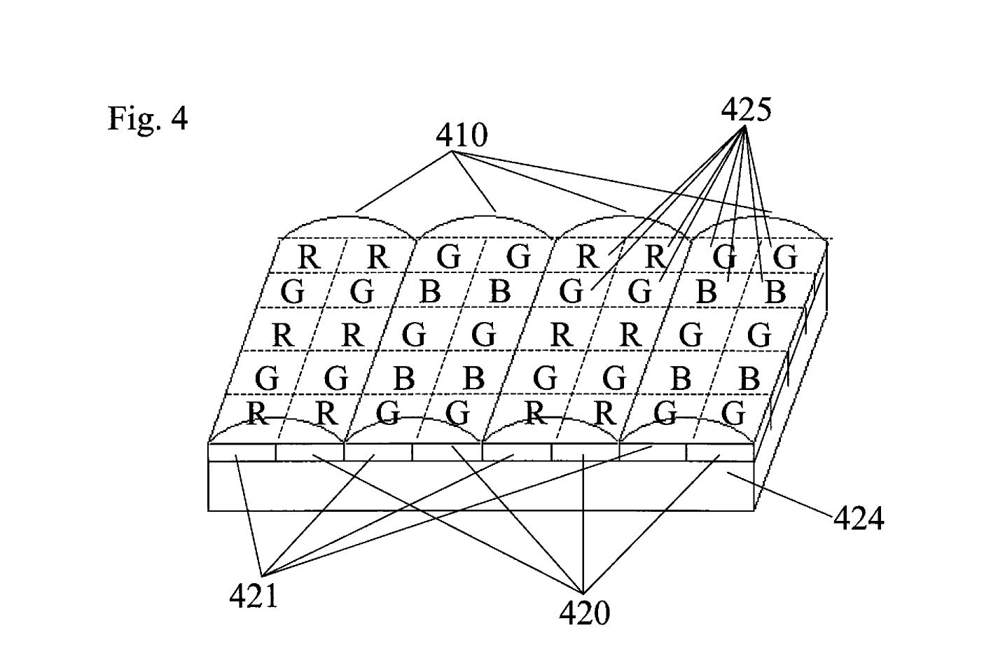

FIG. 4 shows a schematic depiction of a color filter array and associated plurality of pixels 425 under an array of cylindrical microlenses 410. In FIG. 4, the letters R, G, B designate the color filters on each pixel. The color filter array and associated pixels 425 are arranged in a subset of the plurality of pixels 425 under each of the microlenses 410. In other words, the pixels under one cylindrical microlens 410 are considered a “subset of pixels” of the plurality of pixels 425. The first portion 421 of each subset of pixels is arranged to gather the radiation from the left half of the imaging lens aperture 317. Similarly, the second portion 420 of each subset of pixels is arranged to gather the radiation from the right half of the imaging lens aperture 316. The pixel data from the first portions 421 is used to form a first image with a first perspective and the pixel data from the second portion 420 is used to form a second image with a second perspective. To provide uniformly high quality images, the color filter array and associated pixels 425 are arranged symmetrically about the centerline of the cylindrical microlens 41 0. For the color filter array shown in FIG. 4 for the cylindrical microlens 410 on the left side of the image sensor 424, there are shown alternating red and green pixels for the first portion of the subset of pixels 421 next to alternating red and green pixels for the second portion of the subset of pixels 420. For the next cylindrical microlens to the right, alternating green and blue pixels are shown for the first portion of the subset of pixels 421 next to alternating green and blue pixels for the second portion of the subset of pixels 420.

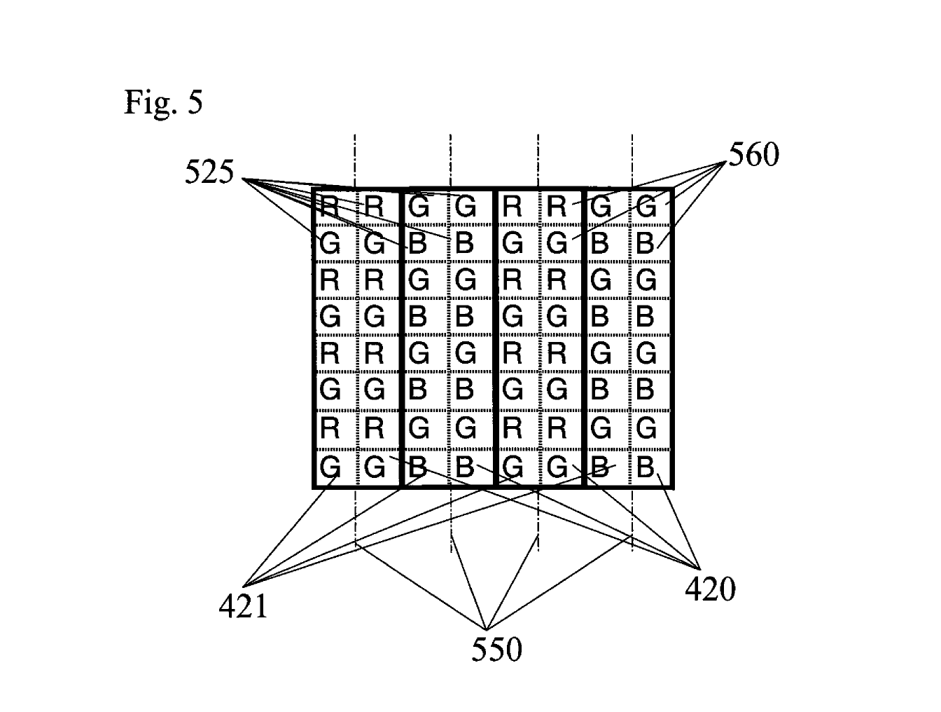

FIG. 5 shows the color filter array 525 by itself as described as an embodiment of the invention where the solid lines mark the edges of the cylindrical microlenses, the dashed lines mark the edges of the pixels and the R, G, B letters indicate the red, green and blue color filter arrays on the pixels. The color filter array is symmetric about the vertical centerlines of the cylindrical microlenses 550. The cylindrical microlenses 410 for this arrangement are two pixels wide and the first and second portions of the pixel subsets (421 and 420) are each one pixel wide under each portion or half of a cylindrical microlens 410. A complete set of color information (red, green and blue) is obtained by combining the pixel data from the respective portions of the pixel subsets under two cylindrical microlenses 410. The radiation gathered by the first portions 421 of the subset of pixels for the first image (gathered through the left half of the imaging lens aperture 317) should be very similar in terms of intensity and color spectrum as compared to the radiation gathered by the second portions 420 of the subset of pixels for the second image (gathered through the right half of the imaging lens aperture 316). Those skilled in the art will note that the color filter array as shown in FIG. 5 for each portion of the subset of pixels (421 and 420) is arranged in the well known Bayer block pattern 560 of red, green and blue pixels, it is just spread between two adjacent cylindrical microlenses 410.

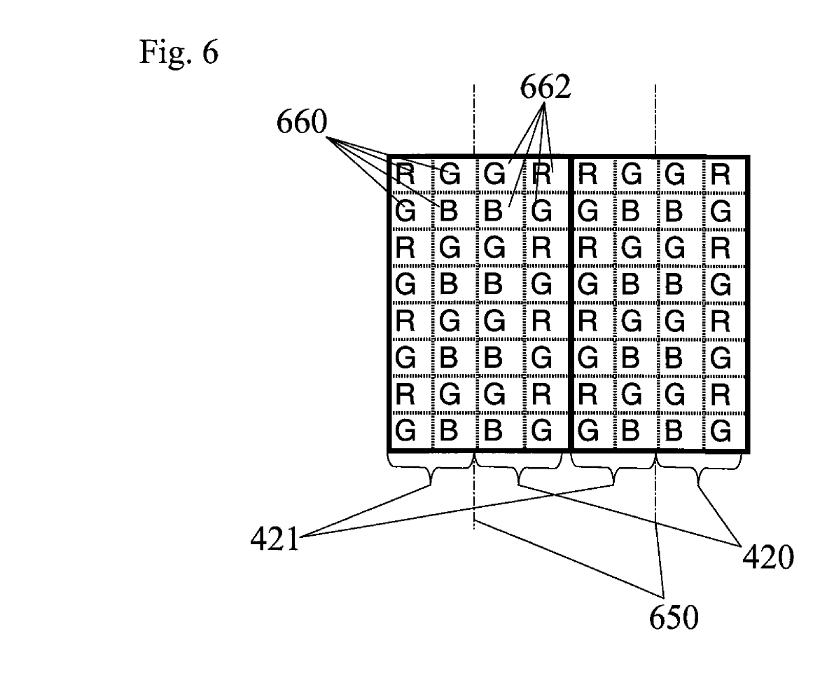

FIG. 6 shows another color filter array pattern as arranged under the cylindrical microlenses and as described as another embodiment of the invention. As with the previous color filter array pattern, the color filter array pattern is arranged symmetrically about the vertical centerlines of the cylindrical microlenses 650. The cylindrical microlenses for this arrangement are four pixels wide and the first and second portions of the pixel subsets (421 and 420) are two pixels wide under each cylindrical microlens. In this case, alternating Bayer block patterns of red, green and blue pixels 660 are arranged vertically as shown in FIG. 6 for the first portion of the subset of pixels 421. For the second portion of the subset of pixels 420 to be symmetric about the vertical centerlines of the cylindrical microlenses 650, alternating horizontally inverted Bayer blocks patterns of red, green and blue pixels 662 are provided. This arrangement provides complete sets of color information (red, green and blue) within the pixel data taken from the first and second portions of the pixel subsets for the first and second images under each of the cylindrical microlenses.

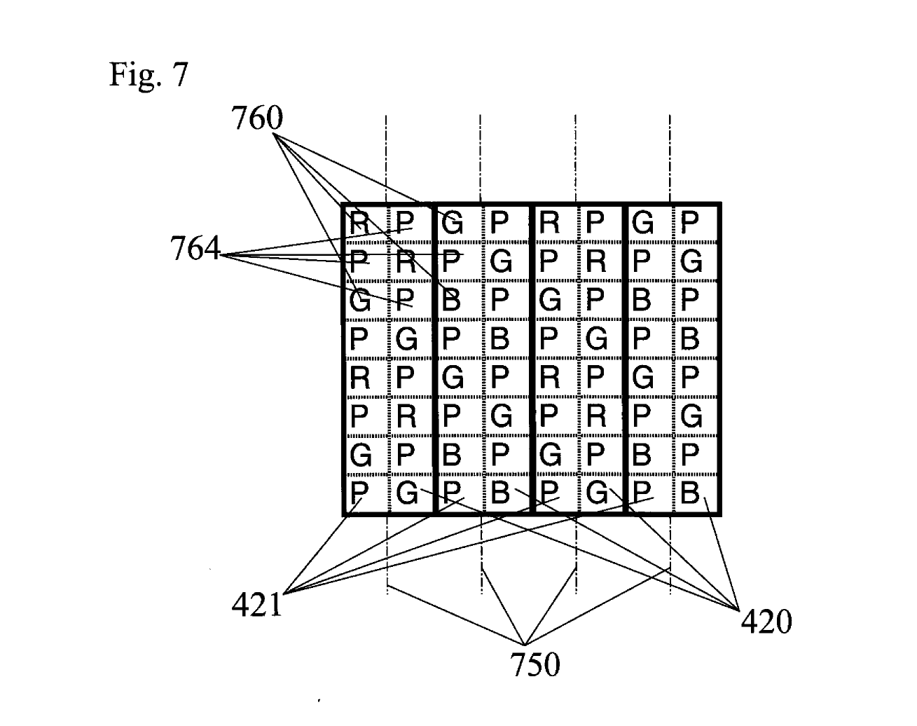

FIG. 7 shows an embodiment of the invention wherein the color filter array pattern includes red, green, blue and panchromatic pixels. While the red, green and blue pixels gather light substantially only from their ⅓ respective portion of the visible spectrum, panchromatic pixels gather light from substantially the entire visible spectrum and as such the panchromatic pixels are approximately 3× more sensitive to the multispectrum lighting found in most scenes being photographed. The cylindrical microlenses for this arrangement are two pixels wide and the first and second portions of the pixel subsets (421 and 420) are each 1 pixel wide under each cylindrical microlens. Similar to the color filter array pattern shown in FIG. 5, the Bayer block pattern 760 is split between two adjacent cylindrical microlenses. However, in this embodiment, panchromatic pixels are uniformly intermingled in a checkerboard pattern 764 within the Bayer block pattern 760. This arrangement produces a color filter array pattern that is symmetric about the centerlines of the cylindrical microlenses 750 with a 1 pixel vertical shift between the first portion of the subset of pixels 421 and the second portion of the subset of pixels 420.

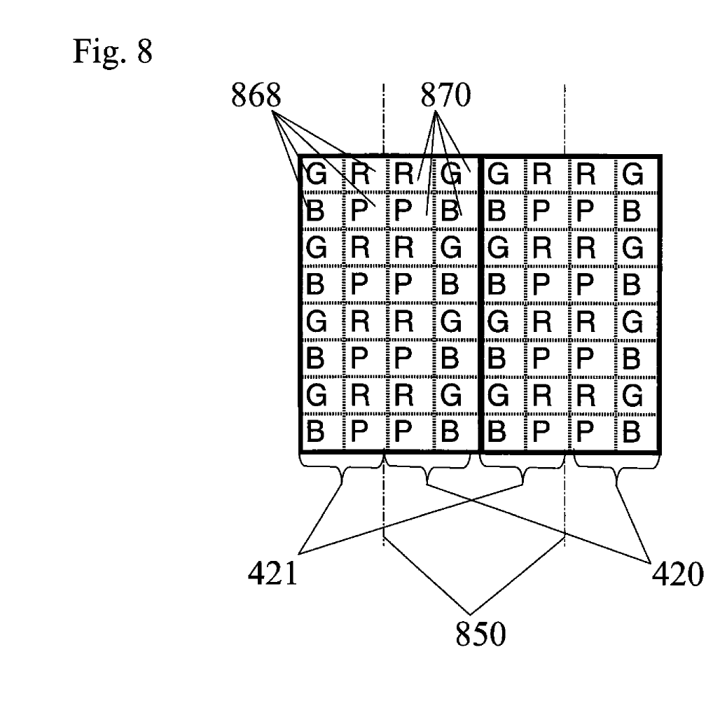

FIG. 8 shows another embodiment of the invention wherein the color filter array includes red, green, blue and panchromatic pixels. The cylindrical microlenses for this arrangement are four pixels wide and the first and second portions of the pixel subsets (421 and 420) are each two pixels wide under each cylindrical microlens. In this embodiment, the color filter array is arranged in blocks which contain red, green, blue and panchromatic pixels. The red/green/blue/panchromatic block 868 for the first portions 421 of the subset of pixels is inverted as compared to the red/green/blue/panchromatic block 870 for the second portions 420 of the subset of pixels as shown in FIG. 8. This arrangement provides complete sets of color information (red, green and blue) along with panchromatic information for each portion of the pixel subset under each cylindrical microlens, while also providing a symmetric color filter array pattern about the centerlines of the cylindrical microlenses 850 to provide very similar radiation intensity and color spectrum to the first and second portions of the pixel subsets (421 and 420) that are used to create the first and second images.

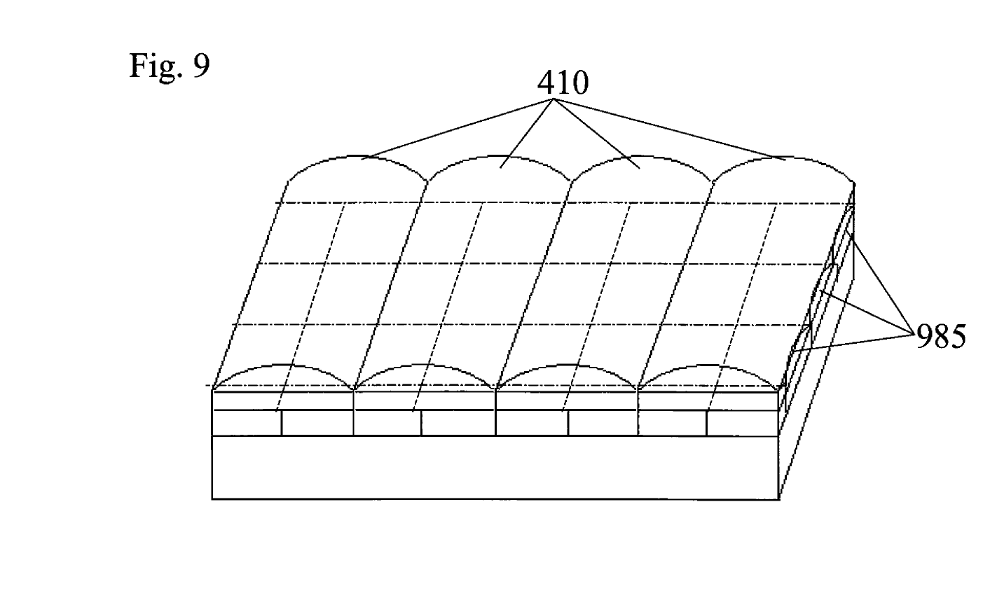

FIG. 9 shows a schematic depiction of an image sensor as described by the invention wherein the cylindrical microlenses 410 are positioned over a second set of microlenses 985 that are used to focus the radiation onto the active areas of the pixels to increase the efficiency of gathering the radiation. The active areas of the pixels are typically smaller than the pixel area as a whole. The second set of microlenses 985 are 1 pixel wide and they can be cylindrical or more preferentially, they are shaped to match the individual pixels (square, rectangular or octagonal).

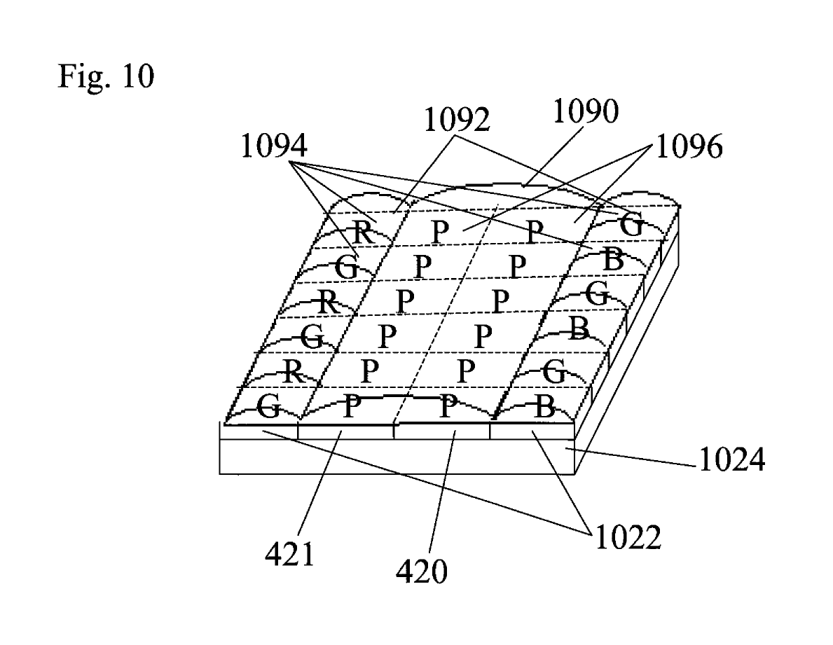

FIG. 10 shows a schematic depiction of yet another embodiment of the invention which includes an image sensor 1024 with red, green, blue 1094 and panchromatic pixels 1096. Cylindrical microlenses 1090 are arranged over the panchromatic pixels 1096 and individual microlenses 1092 are arranged over each pixel of the red, green and blue pixels 1094. In this embodiment, the first portions 421 of the subsets of pixels and the second portions 420 of the subsets of pixels whose pixel data is respectively used to form the first and second images (which have different perspectives) include panchromatic pixels only and as such are arranged under cylindrical microlenses 1090. In contrast to the other embodiments of the invention, this embodiment has another set of two subsets of pixels 1022 including red, green and blue pixels which gather radiation from the entire imaging lens aperture (including 317 and 315) since the another set of two subsets of pixels are arraigned under individual microlenses and as such have a perspective that is between the perspectives for the first and second images. In this embodiment, the 3 dimensional information would be provided from the different perspectives of the first and second images while a final image would be formed from portions of the first and second portions of the pixel subsets (421 and 420) along with the color information from the another set of two subsets of pixels 1022.

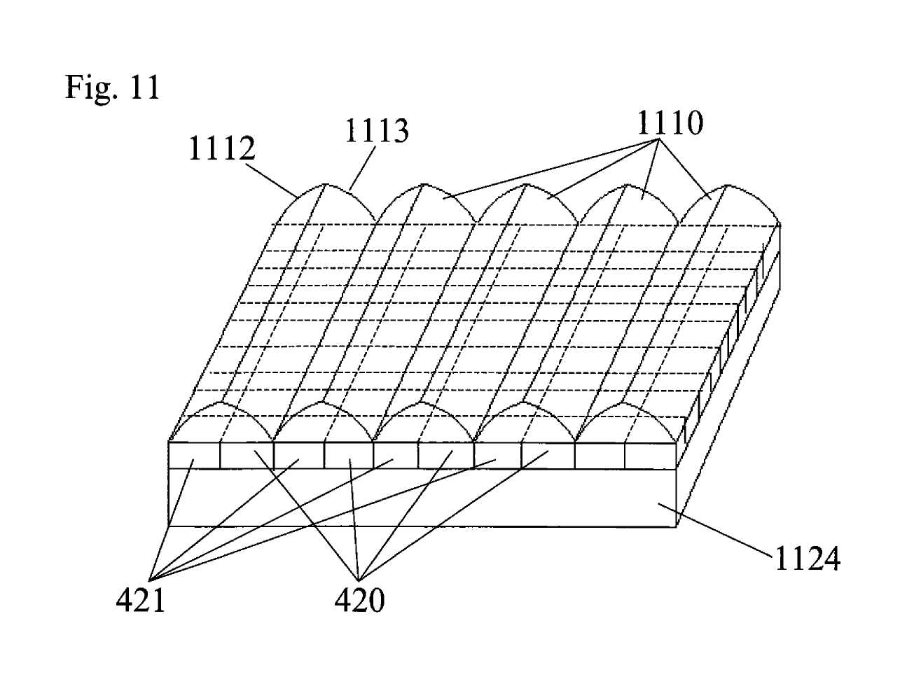

FIG. 11 shows another embodiment of the cylindrical microlenses in which the cylindrical microlenses are aspheric in cross-section. By using aspheric cylindrical microlenses 1110, the effectiveness of each side of the cylindrical microlens (1112 and 1113) to gather radiation from only one half of the imaging lens 230 can be improved. In addition, the microlenses can be tilted or slightly offset to further improve the effectiveness of each side of the cylindrical microlens (1112 and 1113) for gathering radiation from only one half of the imaging lens. Thus, each aspheric cylindrical microlens 1110 on the image sensor 1124 can be designed such that each portion of the aspheric cylindrical microlens (1112 and 1113 for the left and right portions of the aspheric cylindrical microlens) is individually designed in terms of shape, angle and lateral position to gather radiation from only the desired half of the imaging lens aperture and focus the radiation onto the desired portion of the subset of pixels. As a result of the individual design of each side (1112 and 1113) of the aspheric cylindrical microlens 1110, the aspheric cylindrical microlens can be asymmetric in cross-section. As shown in FIG. 11, the left portion of the aspheric cylindrical microlens 1112 would gather radiation from the left half of the imaging lens 317 and focus that radiation onto the first portion of the subset of pixels 421. In contrast, the right portion of the aspheric cylindrical microlens 1113 would gather radiation from the right half of the imaging lens 316 and focus that radiation onto the second portion of the subset of pixels 420. As shown in FIG. 11, an aspheric cylindrical lens 1110 that has two portions or halves (1112 and 1113) that have been designed to better gather light from only one half of the imaging lens will typically have a sharp curve change or ridge along the centerline of the cylindrical microlens surface where the two portions of the lens surface (1112 and 1113 for left and right portions as shown) meet.

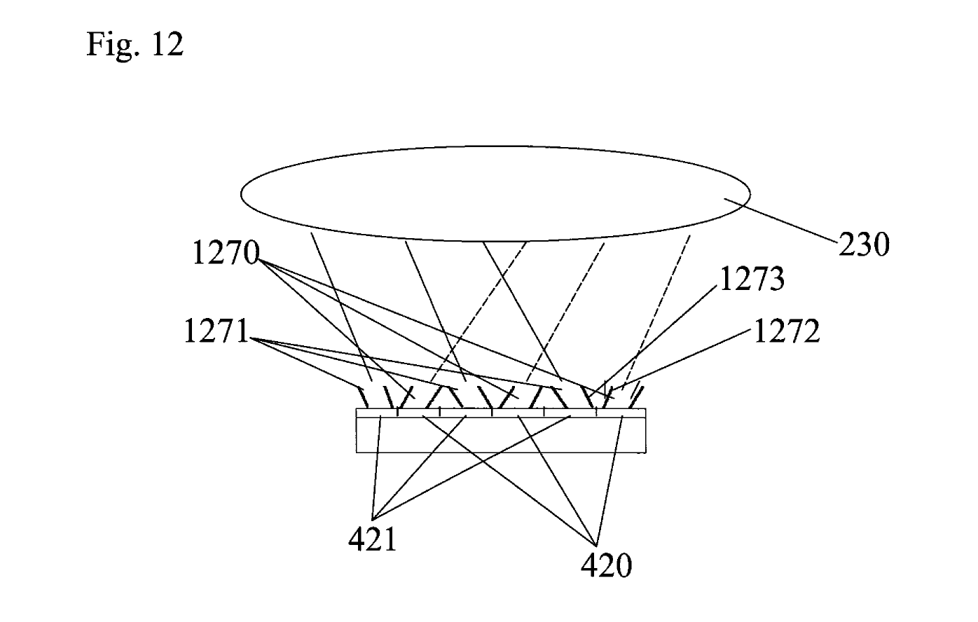

FIG. 12 shows an alternate embodiment of the invention wherein pairs of linear light guides 1270 and 1271 are used in place of cylindrical microlenses to guide the radiation from only one half of the imaging lens 230 to the desired subset of pixels. As shown, the linear light guides 1271 gather radiation that passes through the left half of the imaging lens 230 so that the radiation impinges onto the first portion of the subset of pixels 421. Similarly, the linear light guides 1270 gather radiation that passes through the right half of the imaging lens 230 so that the radiation impinges onto the second portion of the subset of pixels 420. To direct the radiation efficiently without causing light to scatter, the linear light guides 1271 and 1270 can be made with reflective surfaces 1272 above the pixel subsets that the radiation is directed toward the pixel surface and with absorbing surfaces 1273 on the surfaces that are between the pixel subsets. In addition, the surfaces of the linear light guides 1271 and 1272 can be made with curved surfaces, tilted surfaces or offset surfaces to help focus the radiation onto the desired pixel subsets. Further, the linear light guides 1271 and 1272 can be used with all the color filter array patterns as described with the cylindrical microlenses.

The invention has been described in detail with particular reference to certain preferred embodiments thereof, but it will be understood that variations and modifications can be effected within the spirit and scope of the invention.

### Parts List

110 Cylindrical microlens
120 Pixels
121 Pixels
124 Image sensor
126 Light rays
128 Light rays
130 Imaging lens
210 Cylindrical microlenses
220 Pixel subset
221 Pixel subset
224 Image sensor
226 Light rays
228 Light rays
230 Imaging lens
315 Imaging lens aperture
316 Imaging lens aperture
317 Imaging lens aperture
318 Imaging lens aperture
410 Cylindrical microlens
420 Pixels
421 Pixels
424 Image sensor
425 Pixels
525 Filter array
550 Cylindrical microlenses
560 Bayer block pattern
650 Cylindrical microlenses
660 Pixels
662 Pixels
750 Cylindrical microlenses
760 Bayer block pattern
764 Checkerboard pattern
850 Cylindrical microlenses
868 Panchromatic block
870 Panchromatic block
985 Microlenses
1022 Pixels
1024 Image sensor
1090 Cylindrical microlenses
1092 Individual microlenses
1094 Pixels
1096 Pixels
1110 Aspheric cylindrical microlenses
1112 Cylindrical microlens
1113 Cylindrical microlens
1124 Image sensor
1270 Linear light guide
1271 Linear light guide
1272 Reflective surface
1273 Absorbing surface

1. An image acquisition system comprising:
an image sensor comprising a plurality of pixels; and
a plurality of cylindrical microlenses formed on a surface, the surface being on or above the image sensor,
wherein each cylindrical microlens is configured to focus radiation on a subset of the plurality of pixels, and
wherein each cylindrical microlens has a first portion configured to focus radiation on a first portion of its subset of pixels, and a second portion configured to focus radiation on a second portion of its subset of pixels.

2. The image acquisition system of claim 1, wherein the first portions of the cylindrical microlenses and the second portions of the cylindrical microlenses are halves of the respective microlenses, and wherein the first portions of the subsets of pixels and the second portions of the subsets of pixels are halves of the respective subsets of pixels.

3. The image acquisition system of claim 1, wherein each subset of pixels is arranged symmetrically.

4. The image acquisition system of claim 1, wherein the surface comprises a layer of microlenses other than said cylindrical microlenses.

5. The image acquisition system of claim 1, wherein the microlenses are aspheric.

6. The image acquisition system of claim 5, wherein the microlenses are tilted or offset.

7. The image acquisition system of claim 5, wherein the microlenses are asymmetric in cross-section.

8. The image acquisition system of claim 1, further comprising an imaging lens located at a distance from the image sensor and having a position that directs radiation through the cylindrical microlenses and onto the image sensor,
wherein each cylindrical microlens focuses radiation from the imaging lens onto its subset of the plurality of pixels,
wherein the first portion of each cylindrical microlens focuses radiation from a first portion of the imaging lens onto the first portion of its subset of pixels, and
wherein the second portion of each cylindrical microlens focuses radiation from a second portion of the imaging lens onto the second portion of its subset of pixels.

9. The image acquisition system of claim 8, wherein the first portions of the cylindrical microlenses and the second portions of the cylindrical microlenses are halves of the respective microlenses, wherein the first portions of the subsets of pixels and the second portions of the subsets of pixels are halves of the respective subsets of pixels, and wherein the first portion of the imaging lens and the second portion of the imaging lens are halves of the imaging lens.

10. An image acquisition system comprising:
an image sensor comprising a plurality of pixels; and
a plurality of light guide pairs formed on a surface, the surface being on or above the image sensor,
wherein each light guide pair is configured to focus radiation on a subset of the plurality of pixels, and
wherein each light guide pair has a first light guide configured to focus radiation on a first portion of the respective light guide pair's subset of pixels, and a second light guide configured to focus radiation on a second portion of the respective light guide pair's subset of pixels.

11. The image acquisition system of claim 10, wherein the first portions of the subsets of pixels and the second portions of the subsets of pixels are halves of the respective subsets of pixels.

12. The image acquisition system of claim 10, wherein each subset of pixels is arranged symmetrically.

13. The image acquisition system of claim 10, further comprising an imaging lens located at a distance from the image sensor and having a position that directs radiation through the light guide pairs and onto the image sensor,
wherein each light guide pair focuses radiation from the imaging lens onto its subset of the plurality of pixels, and
wherein the first light guide of each light guide pair focuses radiation from a first portion of the imaging lens onto the first portion of its subset of pixels, and
wherein the second light guide of each light guide pair focuses radiation from a second portion of the imaging lens onto the second portion of its subset of pixels.

14. The image acquisition system of claim 13, wherein the first portions of the subsets of pixels and the second portions of the subsets of pixels are halves of the respective subsets of pixels, and wherein the first portion of the imaging lens and the second portion of the imaging lens are halves of the imaging lens.
